(19) United States
(12) Patent Application Publication
(10) Pub. No.: US 2017/0192880 A1
(43) Pub. Date: Jul. 6, 2017

(54) DEFECT PREDICTION

(71) Applicant: HCL Technologies Limited, Uttar Pradesh (IN)

(72) Inventors: Dinesh Babu RAMAKRISHNAN, Chennai (IN); Venkatesh SHANKAR, Chennai (IN); Padmajaya BHAGAVATHIAMMAL, Chennai (Madras) (IN)

(21) Appl. No.: 15/399,551

(22) Filed: Jan. 5, 2017

(30) Foreign Application Priority Data
Jan. 6, 2016 (IN) 201611000512

(51) Int. Cl. G06F 11/36; G06N 99/00

(52) U.S. Cl. CPC G06F 11/3672; G06N 99/005

(57) ABSTRACT

Disclosed is a method and system for providing a defect template for software testing. The method comprising obtaining data associated with one or more test cases and one or more defects and mapping the one more test cases with the one or more defect cases based on the data. The method further comprises generating one or more defect templates based on the one or more defect cases. The method furthermore comprises receiving a new test case and providing a defect template from the one or more defect templates based on the mapping and the new test case. The method furthermore comprises updating a defect template library based on one or more user inputs for machine learning.

### PRIORITY INFORMATION

The present application claims priority from Indian Patent Application No. 201611000512, filed on Jan. 06, 2016, the entirety of which is hereby incorporated by reference.

### TECHNICAL FIELD

The present subject matter described herein, in general, relates to a system and a method for software testing, and more particularly a system and a method for providing a defect template for software testing.

### BACKGROUND

Generally, numerous defects can be identified in any developed software product. Further, for assuring quality, of the developed software product to customer, software testing is typically performed. Furthermore, software testing is a major area of software industry. Software testing may be understood as an examination conducted to provide stakeholders with information about the quality of a software testing. Identifying and eliminating defects early in the product development life cycle always saves a huge cost, time and efforts. Typically, software testing can also provide an objective, independent view of the software to allow the business to appreciate and understand the risks of software implementation. Further, test techniques include the process of executing a program or application with the intent of finding software bugs, errors or other defects. Upon identification of software bugs, errors or other defects a lot of efforts time and money is spent in, documenting the error, rectifying the error tracking the error to closure. In this phase, multiple factors such unsatisfactory defect capture, incorrect information, lack of clarity in error information results in developers spending increased time and effort in order to identifying and fix the error. Furthermore, the conventional systems and methods fail to identify any possible failures of a test case and to help in defect prediction while writing new test case.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to a system and a method for providing a defect template for software testing. This summary is not intended to identify essential features of the claimed subject matter nor is it intended for use in determining or limiting the scope of the claimed subject matter.

In one implementation, a system for providing a defect template for software testing is disclosed. In one aspect, the system may obtain data associated with one or more test cases and one or more defects. The data may comprise test case data and defect data. Furthermore, the test case data comprises a case description, environment data, test history data, report data, and the defect data may comprise a defect description, messages data, and defect history data. Upon obtaining, the system may map the one more test cases with the one or more defect cases based on the data. Further to mapping, the system may generate one or more defect templates based on the one or more defect cases. Subsequent to the generation, a new test case may be received. The new test case comprises one or more of new test title, new test description, new test execution steps, and new test procedures. Upon receiving, a defect template may be provided from the one or more defect templates based on the mapping and the new test case.

In one implementation, a method for providing a defect template for software testing is disclosed. In one aspect, the method may comprise obtaining data associated with one or more test cases and one or more defects. Further, the data may comprise test case data and defect data. Furthermore the test case data may comprise a case description, environment data, test history data, report data, and the defect data may comprise a defect description, messages data, and defect history data. The method may further comprise mapping the one more test cases with the one or more defect cases based on the data and generating one or more defect templates based on the one or more defect cases. The method may furthermore comprise receiving a new test case. Further, the new test case comprises one or more of new test title, new test description, new test execution steps, and new test procedures. The method may further comprise providing a defect template from the one or more defect templates based on the mapping and the new test case.

In yet another implementation, non-transitory computer readable medium embodying a program executable in a computing device for providing a defect template for software testing is disclosed. In one aspect, the program may comprise a program code for obtaining data associated with one or more test cases and one or more defects. Further, the data may comprise test case data and defect data. Furthermore, the test case data may comprise a case description, environment data, test history data, report data, and the defect data may comprise a defect description, messages data, and defect history data. The program may comprise a program code for mapping the one more test cases with the one or more defect cases based on the data. The program may comprise a program code for generating one or more defect templates based on the one or more defect cases. The program may comprise a program code for receiving a new test case, wherein the new test case comprises one or more of new test title, new test description, new test execution steps, and new test procedures. The program may comprise a program code for providing a defect template from the one or more defect templates based on the mapping and the new test case.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for providing a defect template for software testing, in accordance with an embodiment of the present subject matter.

FIG. 2 illustrates the system providing a defect template for software testing, in accordance with an embodiment of the present subject matter.

FIG. 3 illustrates a method for providing a defect template for software testing, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods for providing a defect template for software testing, similar or equivalent to those described herein can be used in the practice or testing of embodiments of the present disclosure, the exemplary, systems and methods for providing a defect template for software testing are now described. The disclosed embodiments for providing a defect template for software testing are merely examples of the disclosure, which may be embodied in various forms.

Various modifications to the embodiment will be readily apparent to those skilled in the art and the generic principles herein may be applied to other embodiments for providing a defect template for software testing. However, one of ordinary skill in the art will readily recognize that the present disclosure for providing a defect template for software testing is not intended to be limited to the embodiments described, but is to be accorded the widest scope consistent with the principles and features described herein.

In an implementation, a system and method for providing a defect template for software testing, is described. In one embodiment, data associated with one or more test cases and one or more defects may be obtained. Further, the data may comprise test case data and defect data. Furthermore, the test case data may comprise a case description, environment data, test history data, report data, and the defect data may comprise a defect description, messages data, and defect history data. Upon obtaining data, the one more test cases with the one or more defect cases may be mapped based on the data. Further to mapping of the one more test cases with the one or more defect cases, one or more defect templates may be generated based on the one or more defect cases. Subsequent to generating one or more defect templates, a new test case may be received. The new test case may comprise one or more of new test title, new test description, new test execution steps, and new test procedures. Upon receiving a new test case, a defect template from the one or more defect templates may be provided based the mapping and the new test case.

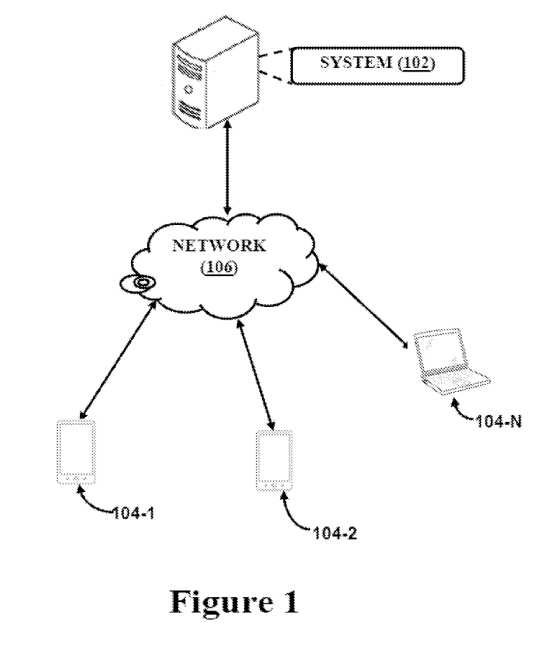

Referring now to FIG. 1, a network implementation of a system 102 for providing a defect template for software testing, in accordance with an embodiment of the present subject matter may be described. In one embodiment, the present subject matter is explained considering that the system 102 may be implemented as a standalone system connects to a network. It may be understood that the system 102 may also be implemented in a variety of computing systems, such as a laptop computer, a desktop computer, a notebook, a workstation, a mainframe computer, a server, a network server, a cloud-based computing environment and the like.

In one implementation, the system 102 may comprise the cloud-based computing environment in which the user may operate individual computing systems configured to execute remotely located applications. In another embodiment, the system 102 may also be implemented on a client device hereinafter referred to as a user device 104. It may be understood that the system implemented on the client device supports a plurality of browsers and all viewports. Examples of the plurality of browsers may include, but not limited to, Chrome™, Mozilla™, Internet Explorer™, Safari™, and Opera™. It will also be understood that the system 102 may be accessed by multiple users through one or more user devices 104-1, 104-2 . . . and 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

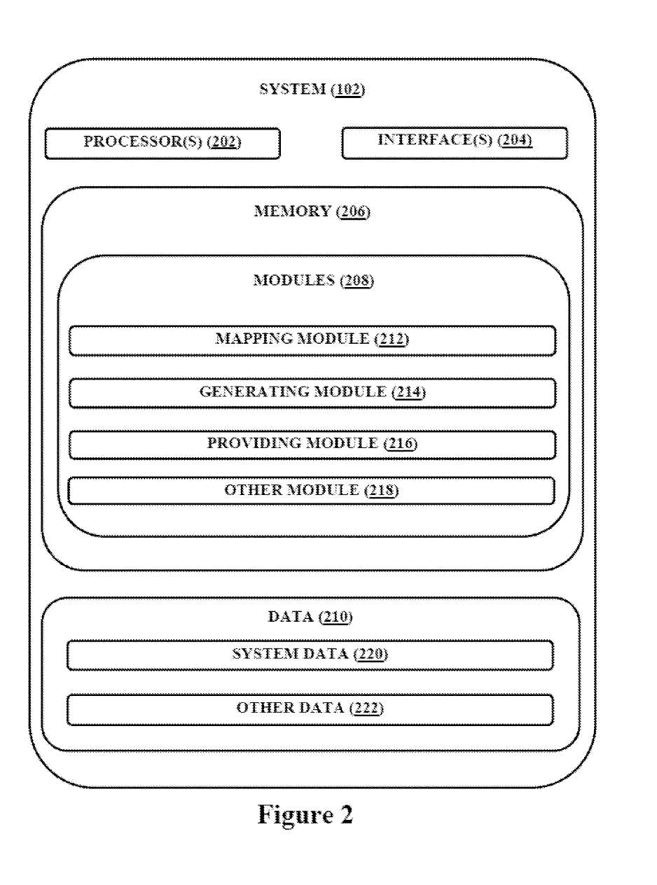

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a mapping module 212, a generating module 214, a providing module 216 and other module 218. The other modules 218 may include programs or coded instructions that supplement applications and functions of the system 102. The modules 208 described herein may be implemented as software modules that may be executed in the cloud-based computing environment of the system 102.

The memory 206, amongst other things, serves as a repository for storing data processed, received, and generated by one or more of the modules 208. The memory 206 may include data generated as a result of the execution of one or more modules in the other module 220. In one implementation, the memory may include data 210. Further, the data 210 may include a system data 220 for storing data processed, computed received and generated by one or more of the modules 208. Furthermore, the data 210 may include other data 224 for storing data generated as a result of the execution of one or more modules in the other module 220.

In one implementation, at first, a user may use the client device 104 to access the system 102 via the I/O interface 204. The user may register using the I/O interface 204 in order to use the system 102. In one aspect, the user may access the I/O interface 204 of the system 102 for obtaining information or providing input information. In one implementation the system 102 my automatically provide information to the user through I/O interface 204.

Mappinng Module 212

Referring to FIG. 2, in an embodiment the mapping module 212 may obtain data associated with one or more test cases and one or more defects. Further, the data may comprise test case data and defect data. Furthermore, the test case data may comprise a case description, environment data, test history data, report data, title, summary, test execution procedure, pass/fail scenario, and expected results. The defect data may comprise a defect description, messages data, and defect history data. In the embodiment, the mapping module 212 may store the obtained data in system data 220.

In one example, the mapping module 212 may periodically obtain data from external data sources such as Test Management System and Defect Management System. Test and defect details obtained by the mapping module 212 stored in Test related tables and Defect related tables respectively in the database of system data 220.

Upon obtaining data, the mapping module 212 may identify critical data from the data based on predefined rules. Further, the critical data may comprise the case description and the defect description. In the embodiment, the mapping module 212 may store the critical data in system data 220. Further to identifying critical data, the mapping module 212 may map the one more test cases with the one or more defect cases based on the critical data and data. In the embodiment, the mapping module 212 may store the mapping in system data 220.

In one example further to identifying critical data, the mapping module 212 may predict test case-defect mapping based on text content processing of the data. Further, the mapping module 212 may compare the predicted test case-defect mapping with available test case-defect mapping in the external data sources such as Test Management System and Defect Management System. Subsequently, the mapping module 212 may store the mapping in system data 220.

Generating Module 214

In the implementation, the generating module 214 may generate one or more defect templates. In one example, the defect template may be understood as a defect report that documents an anomaly discovered during software testing. The defect template may include all the information needed to reproduce the problem, including, problem area, problem description, test environment, defect type, priority, severity, status. Further, the generating module 214 may store the one or more defect templates in system data 220.

In one example, the generating module 214 may generated defect templates based on the defects from the test case-defect mapping. In one embodiment, the generation of defect templates, may be based on duplication of defects in mapped in the test case-defect mapping. Further, the generating module 214 may store the one or more defect templates in a defect template library in the system data 220. The defect template library may comprise defect templates related tables. Further, the defect template may be to test cases based on the previous map. In one embodiment, the defect template library may be updated based on user inputs for machine learning.

The generating module 214 may further generate a developer checklist based on the test case-defect mapping and defect template. The developer checklist may be further utilized by a software developer to take appropriate actions to avoid possible defects while developing the requirement corresponds to the particular test cases and rectify an error in the software. Further, the generating module 214 may store the developer checklist in the system data 220.

Providing Module 216

In the implementation, the providing module 216 may receive a new test case. In one example, the providing module 216 may receive the new test case from a user. The new test case may comprise one or more of new test title, new test description, new test execution steps, and new test procedures. In one other example, the providing module 216 may receive the new test case via a plugin. Further, the providing module 216 may store the new test case in system data 220.

In one embodiment of system 102, user inputs are captured dynamically by a plugin component of the system 102 while the user provides/creates a new test case in test case management. Further, one or more defect templates for new test cases are predicted and provided by the system 102 to the user. In one example, when user selects the provided defect templates and associates the defect templates to the new test case, then the test case details along with mapping will be captured and updated in the system data 220.

In one other embodiment, the defect templates may be customized. Further, if the user updates the existing defect template for a new test case, then a new defect template may be may be generated by the system 102. Furthermore, test case-defect templates map may be updated the new test case and the new defect templates. In one other embodiment, if defect is created newly without defect templates, then the defect may also be captured as a defect template and stored in defect template library of system 220.

Upon obtain the new test case; the providing module 216 may identify one or more of tests cases similar to the new test case from the system data 220. Further, to identifying the similar tests cases the providing module 216 may provide a defect template from the one or more defect templates based on the mapping. The providing module 216 may also store the new defect template from the one or more defect templates in system data 220. In one embodiment, the providing module 216 may updated the defect template library based on user inputs for machine learning of system 102.

Exemplary embodiments for providing a defect template for software testing discussed above may provide certain advantages. Though not required to practice aspects of the disclosure, these advantages may include those provided by the following features.

Some embodiments enable the system and the method to ease the defect management process

Some embodiments enable the system and the method for identification and elimination of frequent defects in a module

Some embodiments enable the system and the method to increase defect fixing rate

Some embodiments enable the system and the method to reduce response time.

Some embodiments enable the system and the method to aid left-shift as it helps developers to test possible failure scenario

Some embodiments enable the system and the method to eliminate issues like defect details discrepancy.

Some embodiments enable the system and the method to eliminate unnecessary communication, misunderstanding of defects, and insufficiency of defect details.

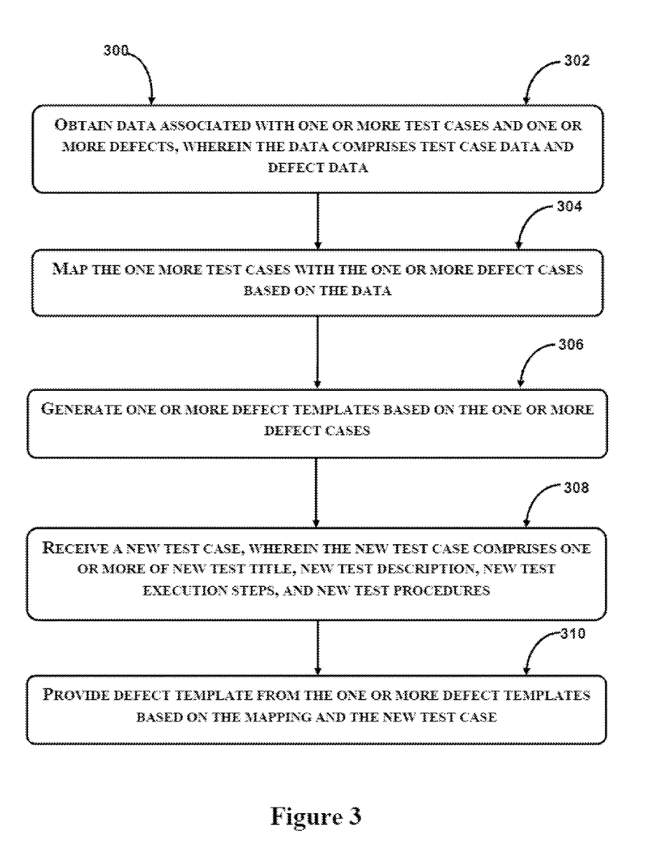

Referring now to FIG. 3, a method 300 for providing a defect template for software testing is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 for providing a defect template for software testing is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, data associated with one or more test cases and one or more defects may be obtained. Further, the data may comprise test case data and defect data. Furthermore, the test case data may comprise a case description, environment data, test history data, report data, and the defect data may comprise a defect description, messages data, and defect history data. In an implementation, mapping module 212 may obtain data associated with one or more test cases and one or more defects and store the data in system data 220.

At block 304, the one or more test cases with the one or more defect cases may be mapped based on the data. In the implementation, the mapping module 212 may map the one or more test cases with the one or more defect cases and store the mapping in system data 220.

At block 306, one or more defect templates may be generated based on the one or more defect cases. In the implementation, the generating module 214 may generate one or more defect templates and store the one or more defect templates in system data 220.

At block 308, a new test case may be received. The new test case may comprise one or more of new test title, new test description, new test execution steps, and new test procedures. In the implementation, the providing module 216 may receive a new test case and store the new test case in system data 220.

At block 310, a defect template from the one or more defect templates may be provided based on the mapping and the new test case. In the implementation, the providing module 216 may provide a defect template from the one or more defect templates and store the defect template from the one or more defect templates in system data 220.

Exemplary embodiments discussed above may provide certain advantages. Though not required to practice aspects of the disclosure, these advantages may include a method for providing a defect template for software testing.

Although implementations for methods and systems for providing a defect template for software testing have been described in language specific to structural features and/or methods, it is to be understood that the appended claims are not necessarily limited to the specific features or methods described. Rather, the specific features and methods are disclosed as examples of implementations for providing a defect template for software testing.

We claim:

1. A method for providing a defect template for software testing, the method comprising:
obtaining, by a processor, data associated with one or more test cases and one or more defects, wherein the data comprises test case data and defect data, and wherein the test case data comprises a case description, environment data, test history data, report data, and wherein the defect data comprises a defect description, messages data, and defect history data;
mapping, by the processor, the one or more test cases with the one or more defect cases based on the data;
generating, by the processor, one or more defect templates based on the one or more defect cases;
receiving, by the processor, a new test case, wherein the new test case comprises one or more of new test title, new test description, new test execution steps, and new test procedures; and
providing, by the processor, a defect template from the one or more defect templates based on the mapping and the new test case.

2. The method of claim 1, further comprises identifying critical data from the data based on predefined rules, wherein the critical data comprises the case description and the defect description.

3. The method of claim 1, further comprises identifying one or more of tests cases similar to the new test case.

4. The method of claim 1, further comprises developing a defect template library based on collation of one or more defect templates.

5. The method of claim 4, further comprises generating a developer checklist based on one or more of the test case-defect mappings and defect template library.

6. The method of claim 4, further comprises updating the defect template library based on one or more user inputs for machine learning.

7. A system for providing a defect template for software testing, the system comprising:
a memory; and
a processor coupled to the memory, wherein the processor is capable of executing instructions to perform steps of:
obtaining data associated with one or more test cases and one or more defects, wherein the data comprises test case data and defect data, and wherein the test case data comprises a case description, environment data, test history data, report data, and wherein the defect data comprises a defect description, messages data, and defect history data;
mapping the one or more test cases with the one or more defect cases based on the data;
generating one or more defect templates based on the one or more defect cases;
receiving a new test case, wherein the new test case comprises one or more of new test title, new test description, new test execution steps, and new test procedures; and
providing a defect template from the one or more defect templates based on the mapping and the new test case.

8. The system of claim 7, further comprises identifying critical data from the data based on predefined rules, wherein the critical data comprises the case description and the defect description.

9. The system of claim 7, further comprises identifying one or more of tests cases similar to the new test case.

10. The system of claim 7, further comprises developing a defect template library based on collation of one or more defect templates.

11. The system of claim 10, further comprises updating the defect template library based on one or more user inputs for machine learning.

12. The system of claim 10, further comprises generating a developer checklist based on the test case-defect mapping and defect template.

13. A non-transitory computer program product having embodied thereon a computer program for providing a defect template for software testing, the computer program product storing instructions, the instructions comprising instructions for:
obtaining data associated with one or more test cases and one or more defects, wherein the data comprises test case data and defect data, and wherein the test case data comprises a case description, environment data, test history data, report data, and wherein the defect data comprises a defect description, messages data, and defect history data;
identifying critical data from the data based on predefined rules, wherein the critical data comprises the case description and the defect description;
mapping the one more test cases with the one or more defect cases based on the data;
generating one or more defect templates based on the one or more defect cases;
receiving a new test case, wherein the new test case comprises one or more of new test title, new test description, new test execution steps, and new test procedures;
identifying one or more of tests cases similar to the new test case; and
providing a defect template from the one or more defect templates based on the mapping and the new test case.
